(19) United States
(12) Patent Application Publication
(10) Pub. No.: US 2016/0179066 A1
(43) Pub. Date: Jun. 23, 2016

(54) CONTEXTUALLY INTERACTIVE APPAREL

(71) Applicant: Intel Corporation, Santa Clara, CA (US)

(72) Inventors: Stephen C. Chadwick, Chandler, AZ (US); Michael T. Moran, Naas (IE); Charles Baron, Chandler, AZ (US); Tobias M. Kohlenberg, Portland, OR (US)

(73) Assignee: Intel Corporation, Santa Clara, CA (US)

(21) Appl. No.: 14/580,882

(22) Filed: Dec. 23, 2014

(51) Int. Cl. G05B 15/02

(52) U.S. Cl. CPC G05B 15/02

(57) ABSTRACT

Technologies are presented that provide contextually interactive apparel in practical implementations and applications. A method for directing a change in an interface of a wearable device may include detecting a trigger and providing a change command to an interface controller of a wearable device based on the trigger. The interface controller may direct a change (e.g., a change in visual pattern, audio, etc.) in an interface of the wearable device, based on the change command, that is perceivable by persons in proximity of the wearable device. The providing the change command may include providing one or more change commands to a plurality of wearable devices in a choreographed manner. The method may further include determining other wearable devices that exist and/or are being concurrently worn within a predetermined proximity of the wearable device, and providing information regarding the other wearable devices.

### TECHNICAL FIELD

The technologies described herein generally relate to wearable computing systems.

### BACKGROUND

Adaptable apparel that is capable of a perceivable change currently includes, for example, battery-operated apparel and accessories (basic LED apparel, lighted jewelry), heat-influenced apparel or accessories (mood rings), etc. Wearable computing devices, such as, for example, watches/jewelry, glasses, shoes, clothing, etc., have become more prevalent in recent times. Many of these wearable devices provide movement detection, biometric sensing, fitness tracking, geo-location, heat, etc. However, there are common situations that current adaptable apparel and wearable computing devices do not address. These situations include, for example, finding someone in a crowd, providing immediate identification and other information, remotely or automatically changing perceivable output or patterns based on context, etc. No known wearable solutions provide these practical uses.

### BRIEF DESCRIPTION OF THE DRAWINGS/FIGURES

FIG. 1 is a block diagram of an example system described herein, according to an embodiment.

FIG. 2 is a block diagram of an example system described herein, including a bridge device, according to an embodiment.

FIGS. 3 and 4 are block diagrams of example systems described herein, using client-server implementations, according to embodiments.

FIG. 5 is a sequence diagram of example usage flows, according to embodiments.

FIG. 6 is a sequence diagram of an example usage flow using a bridge device or server, according to embodiments.

FIG. 7 is a sequence diagram of an example usage flow using a client-server implementation, according to an embodiment.

FIG. 8 is a sequence diagram of an example usage flow using an implementation involving a server and a wearable device.

FIG. 9 is a sequence diagram of an example usage flow with a wearable device as a standalone system, according to an embodiment.

FIGS. 10-12 are block diagrams showing example usage scenarios, according to embodiments.

FIG. 13 is a block diagram of an example server device, according to an embodiment.

FIG. 14 is a block diagram of an example master or client device, according to an embodiment.

FIG. 15 is a block diagram of an example wearable device, according to an embodiment.

FIG. 16 is a block diagram of an example bridge device, according to an embodiment.

FIG. 17 illustrates an example mobile information device in which an embodiment may be implemented.

In the drawings, the leftmost digit(s) of a reference number may identify the drawing in which the reference number first appears.

### DETAILED DESCRIPTION

In the following description, embodiments are presented that provide contextually interactive apparel that may be used in practical implementations and applications, including finding a wearer, protecting a wearer, informing a consumer, preserving uniqueness of apparel, etc. Implementations may range from a standalone wearable device to a master/wearable device implementation to a cloud-based or server-based service. Other implementations and uses may also be contemplated, as would be understood by one of ordinary skill in the relevant art after reading the description herein.

Embodiments are now described with reference to the figures, where like reference numbers indicate identical or functionally similar elements. While specific configurations and arrangements are discussed, it should be understood that this is done for illustrative purposes only. An ordinary person skilled in the relevant art will recognize that other configurations and arrangements can be used without departing from the spirit and scope of the description. It will be apparent to an ordinary person skilled in the relevant art that the concepts described herein may also be employed in a variety of other systems and applications other than what is described herein.

Interactive apparel, as used herein, may include any kind of wearable apparel that may include or support a wearable computing device. The apparel may include, for example, clothing (e.g., any type of shirt, sweater, blouse, dress, pant, short, skirt, sock, shoe, hat, glove, scarf, jacket, coat, cape, etc.) and/or accessories (e.g., jewelry, watch, bag or tote, wearable or carry-able sign, headband, arm or leg band, etc.). A wearable computing device, as used herein, may be any computing device that can be incorporated into, or with, the apparel. The computing device may be permanently attached to the apparel (e.g., sewn in, riveted in, etc.) or removably attached to the apparel (e.g., capable of fitting into a pocket or sleeve sized for the computing device, attached via one or more fastening mechanisms such as snaps, pins, magnets, adhesive, or other types of temporary fasteners, etc.). The wearable computing device may include an interface that may present output that is perceivable by the wearer and/or others in the proximity of the wearable device. For example, the interface may include a visual interface (e.g., a display), an audio interface (e.g., one or more speakers), etc. The visual interface may be electrical- or chemical-based, or include other known display technologies. For example, the display may comprise light emitting diodes (LEDs), optical fiber, etc. The wearable computing device may be powered by battery (such as a removable battery pack or remote), solar energy, piezoelectricity or other motion-based energy, or other known energy and/or power providing technology. As used herein, the terms interactive apparel, adaptive apparel, and wearable device may be used interchangeably.

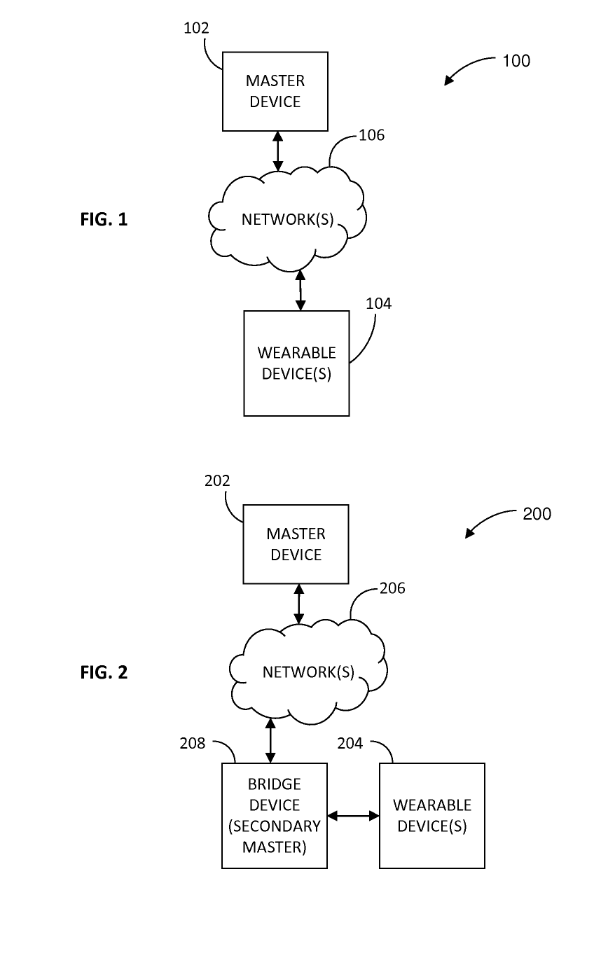

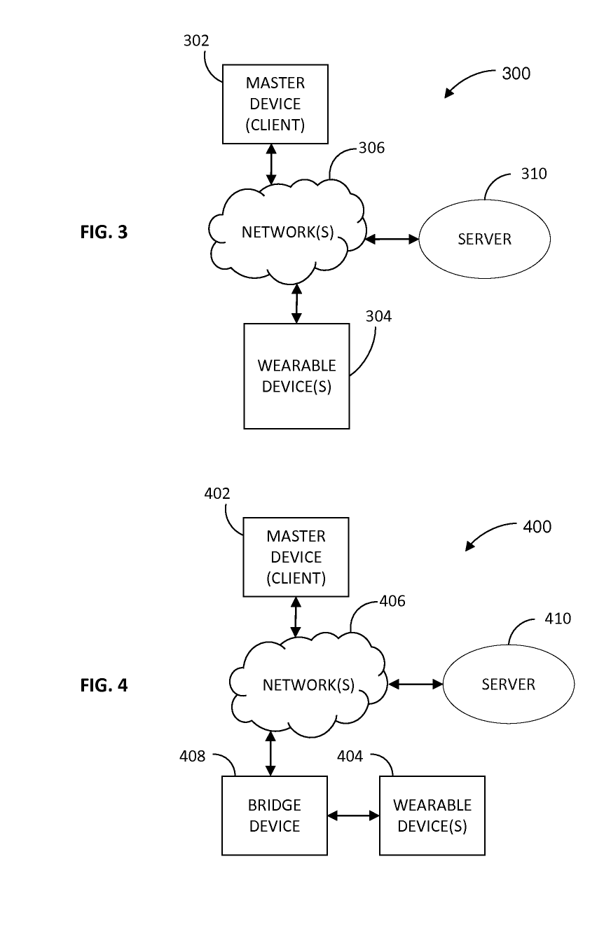

FIGS. 1-4 illustrate various example communication systems in which interactive apparel may be utilized. The example system 100 shown in FIG. 1 may include a master device 102 and one or more wearable devices 104 in communication via one or more networks 106. The example system 200 shown in FIG. 2 may include a master device 202 and one or more wearable devices 204 in communication via one or more networks 206 through a bridge device 208, which may act as a relay between master device 202 and wearable device 204. Bridge device 208 may be used in implementations where, for example, wearable device 204 may not be capable of communicating directly with master device 202 over network 206. In this configuration, bridge device 208 may be considered a secondary master device. In embodiments, bridge device 208 may be a user device of the wearer of wearable device 204, or may be carried by, or be nearby, the wearer of wearable device 204. FIG. 3 depicts an example cloud- or server-based system 300 that may include a master device 302, a server 310, and one or more wearable devices 304 in communication via one or more networks 306. FIG. 4 depicts an example cloud- or server-based system 400 that may include a master device 402, a server 410, and one or more wearable devices 404 in communication via one or more networks 406, where communications with wearable device 404 is through a bridge device 408 similar to previously described bridge device 208 in FIG. 2. Another example system (not shown) may include a standalone wearable device that can be controlled via its own controllers and/or user interfaces. In an embodiment, a standalone wearable device may be configured to detect other wearable devices (e.g., via close-range communications) and information regarding those detected devices, and to execute commands based on the detected information. The actions and features of the components of the examples of FIGS. 1-4, including a standalone wearable device, will be discussed in further detail below.

Wearable devices 104/204/304/404 may include mobile computing devices. Master devices 102/202/302/402 and bridge devices 108/208/308/408 may include mobile and/or non-mobile computing devices. Mobile devices may include, but are not to be limited to, for example, laptop computers, ultra-laptop computers, tablets, touch pads, portable computers, handheld computers, palmtop computers, personal digital assistants (PDAs), e-readers, cellular telephones, combination cellular telephone/PDAs, mobile smart devices (e.g., smart phones, smart tablets, etc.), mobile internet devices (MIDs), mobile messaging devices, mobile data communication devices, mobile media playing devices, cameras, mobile gaming consoles, wands, etc. Non-mobile devices may include, but are not to be limited to, for example, personal computers (PCs), televisions, smart televisions, data communication devices, media playing devices, gaming consoles, etc. These mobile and non-mobile computing devices may include controllers (or processors) and other components that execute software and/or control hardware to execute local programs or remote programs provided by external devices or service providers over a network. For example, these mobile and non-mobile computing devices may include one or more software clients or applications that run locally and/or utilize or access web-based services (e.g., online stores or services, social networking services, etc.). The mobile and non-mobile computing devices may also, or instead, include a web interface running in a browser from which the device can access such web-based services. The mobile and non-mobile computing devices may also include storage devices to store logic and data associated with the programs and services used by the users of the devices.

Servers 310/410 may be implemented in software and/or hardware executed or controlled by a controller or processor. While only one server is illustrated in each of FIGS. 3 and 4 for clarity and ease of discussion, it should be appreciated that the server may include multiple distributed server computers for redundancy and/or load sharing, for example.

As implementation of a wearable device system may be cloud-based, in embodiments, a wearable device system may be implemented similar to a peer-to-peer system where the server 310/410 may also be a master device, which may be a user device of another user. In embodiments, server 310/410 may be master device 102/202/302/402 for which one or more wearable devices are being managed or controlled, or may be another master device in communication with master device 102/202/302/402 and the associated wearable devices via a network. In other embodiments, server 310/410 may be a dedicated server (or group of servers).

Network(s) 106/206/306/406 may include any wired or wireless network, such as a Wide Area Network (WAN), a Local Area Network (LAN), and/or the like. As an example, network(s) 106/206/306/406 may be a distributed public network, such as the Internet, where master device(s), wearable device(s), and server(s) are connected to the network(s) 106/206/306/406 via wired and/or wireless connections. Communication technologies used may include, but are not to be limited to, Bluetooth technology, Wi-Fi technology, near field communication technology, radio frequency (RF) technology, 1G technology, 2G technology, 2.5G technology, 3G technology, 3.5G technology, 4G technology, Long Term Evolution (LTE) technology, WiMAX technology, etc.

A person may become an authorized user of a wearable device in various ways. For example, a person may obtain (e.g., purchase or receive) a wearable device and may download software for controlling the wearable device onto his or her own user device (which may then be considered a master device). In another example, a master device may be included with, and ready to use with, the wearable device. In a further example, a person may become an authorized user of an obtained wearable device by registering through, for example, client software that is downloaded and run on his or her user device or a web-based client running in a browser on his or her user device or another device. When a user registers or otherwise provides setup information, aside from potentially providing identification and contact information, an authorized user may be asked to establish one or more user and/or device profiles that may include preferences, rules, settings, etc., per wearable device or wearer. For example, an authorized user may be asked to provide, or allow a wearable device service to collect, user- and/or wearable device-specific information and/or settings/preferences/rules for usage of the wearable device (e.g., user identification and/or password information, user-, wearer- and/or wearable device-specific settings/preferences/rules, default settings, preferred modes of use, etc.). The registration and/or profile information, which may include settings, preferences, and/or rules, may be stored at the master device, at a server (if applicable), at the wearable device, or a combination of any of these. Storage of information at the server may depend on whether the user authorized such external storage of information that may be personal to the user. In an embodiment, personal information provided to the server may be encrypted. In an embodiment, a user may opt to use recommended settings and/or a recommended profile (e.g., default settings and/or profile) instead of having to create one. A default profile may, for example, be based on crowd-sourced information and/or preferences/settings of other users of wearable device systems or services. In an alternative embodiment, a user may choose not have one or more profiles created. In embodiments, a profile and/or preferences/settings may be edited by the authorized user and/or may be automatically updated based on automatically collected information regarding the usage of the wearable device and associated contextual events. An authorized user may provide further settings (e.g., performance parameters, rules, etc.) for each usage session of the wearable device.

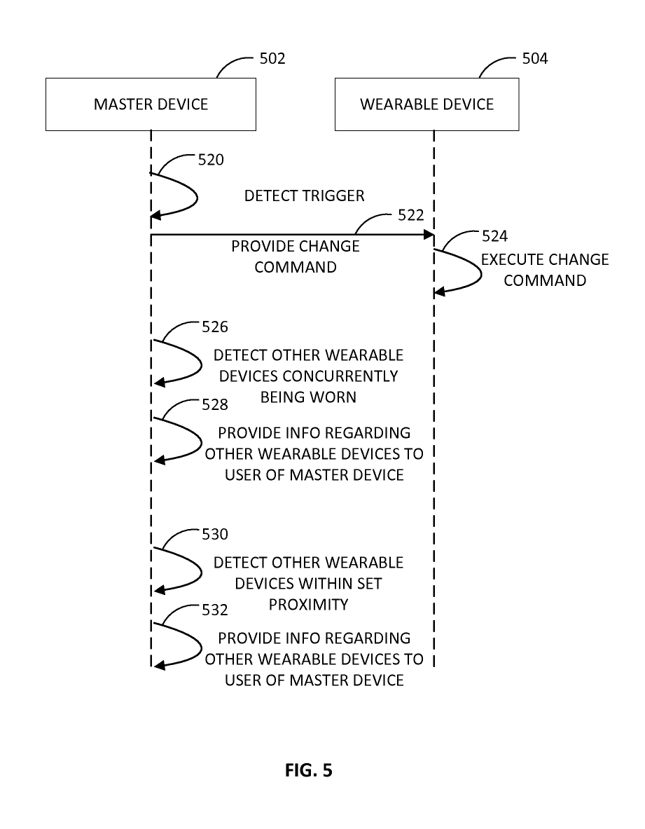

FIGS. 5-9 illustrate example usage flows involving differing device configurations, according to embodiments. These usage flows are examples only and are not meant to be limiting. Many other example usage flows may be contemplated, as would be understood by one of ordinary skill in the relevant art.

FIG. 5 illustrates example usage flows involving a master device 502 and a wearable device 504, according to embodiments. At 520, a trigger may be detected by the master device. An example of a trigger may include an automatic direct request from the master device 502. This type of trigger may be due, for example, to a setting or performance parameter or rule that was set in a default or session profile for wearable device 504. For example, there may be a setting that specifies that wearable device 504 is to change its output (e.g., visual pattern, audio, etc.), or turn on or off, at a certain time, or after a certain amount of time. Master device 502 may detect or determine that the state specified in the setting has occurred. In another example, a trigger may include a request from a user of master device 502 that is input into master device 502 by the user. For example, the user of master device 502 may input, via a user interface on master device 502, a request to change the output of wearable device 504 (e.g., visual pattern, audio, etc.), or turn on or off wearable device 504. Master device 502 may detect or determine that this user request has been made. In a further example, a trigger may include a determination that wearable device 504 is outside a predetermined boundary, or beyond a predetermined proximity of master device 502, based on geo-location information obtained from the wearable device 504, a bridge device used in conjunction with wearable device 504 (if present), and/or master device 502. In yet another example, a trigger may include a determination that an output (e.g., visual pattern, audio, etc.) from another wearable device in a predetermined proximity of wearable device 504 is similar to the current output (e.g., visual pattern, audio, etc.) of wearable device 504, based on geo-location information obtained from the wearable device 504, a bridge device used in conjunction with wearable device 504 (if present), and/or master device 502. Other example triggers may also be contemplated, as would be understood by one of ordinary skill in the relevant art. At 522, master device 502 may provide a change command to wearable device 504 based on the detected trigger. At 524, wearable device 504 may execute the received change command. For example, wearable device 504 may, based on the change command, turn its interface on or off, make a change in a visual pattern displayed on its interface, make a change in audio coming from its interface, etc. Examples of a visual pattern may include, but are not to be limited to, artistic design, text, brightness level (e.g., bright, muted, matte, etc.), colors used, etc.

In embodiments, master device 502 may perform other actions with regard to wearable devices. For example, referring again to FIG. 5, at 526, master device 502 may detect other wearable devices concurrently being worn, and at 528, master device 502 may provide information regarding the detected other wearable devices to a user of master device 502 (e.g., how many, where they are, in what proximity they are to wearable device 504, what output they are presenting, etc.). This feature may be useful in that it may be used to determine whether and/or where there are other wearable devices concurrently being worn that are displaying the same output (visual patter, audio, etc.). With that information, it may be desirable to change the output being displayed on wearable device 504 to preserve uniqueness in apparel, for example. In another example, at 530, master device 502 may detect other wearable devices (e.g., currently being worn and/or not currently being worn) within a predetermined proximity of master device 502 and/or wearable device 504, or even at a particular designated location (city, zip code, shopping area, etc.), and at 532, master device 502 may provide information regarding the detected other wearable devices to a user of master device 502 (e.g., how many there are, where they are located, etc.). This feature may be useful in that it may provide the user with information about location density of wearable devices (e.g., the popularity of a particular wearable device), which may indicate chances of others wearing similar wearable devices/apparel or wearable devices presenting the same or similar output as wearable device 504, where wearable devices may be sold in a particular area, etc. This feature may also provide information to a perspective buyer of a wearable device, who may be deterred from buying a specific wearable device after being informed of the number of that specific wearable device in a specific area or proximity of the store or perspective buyer.

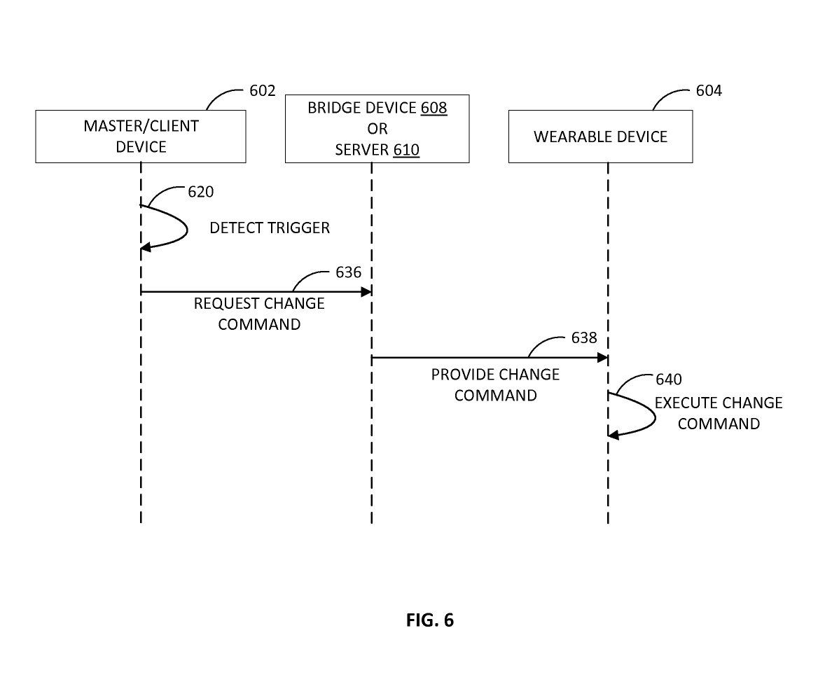

In the example illustrated in FIG. 5, master device 502 may be any of a number of devices. In an embodiment, master device 502 may be a user device of a person other than a wearer of wearable device 504. In another embodiment, master device 502 may be a user device of the wearer of the wearable device. In yet another embodiment, master device 502 may be a server of a cloud-based service for changing interfaces of wearable devices. In a further embodiment, master device 502 may be a bridge device. In a still further embodiment, master device 502 may be wearable device 504 itself. In other words, any of these devices (user device of a wearer, user device of a person other than the wearer, server, bridge device, and/or wearable device itself) may be configured to perform one or more of the actions of a “master” device as described herein. Further examples involving one or more of these device types are depicted in FIGS. 6-8.

FIG. 6 illustrates an example usage flow involving a master (or client) device 602, a bridge device 608 (or a server 610), and wearable device 604. At 620, master device 602 may detect a trigger, similar to the detecting of a trigger as was described above with reference to FIG. 5. At 636, master device 602 may send a request for a change command to bridge device 608 (or server 610). At 638, bridge device 608 (or server 610) may provide the change command to wearable device 604. In this way, in embodiments using server 610, server 610 acts as a bridge device between master device 602 and wearable device 604. At 640, wearable device 604 may execute the change command, similar to the execution of the change command described above with reference to FIG. 5.

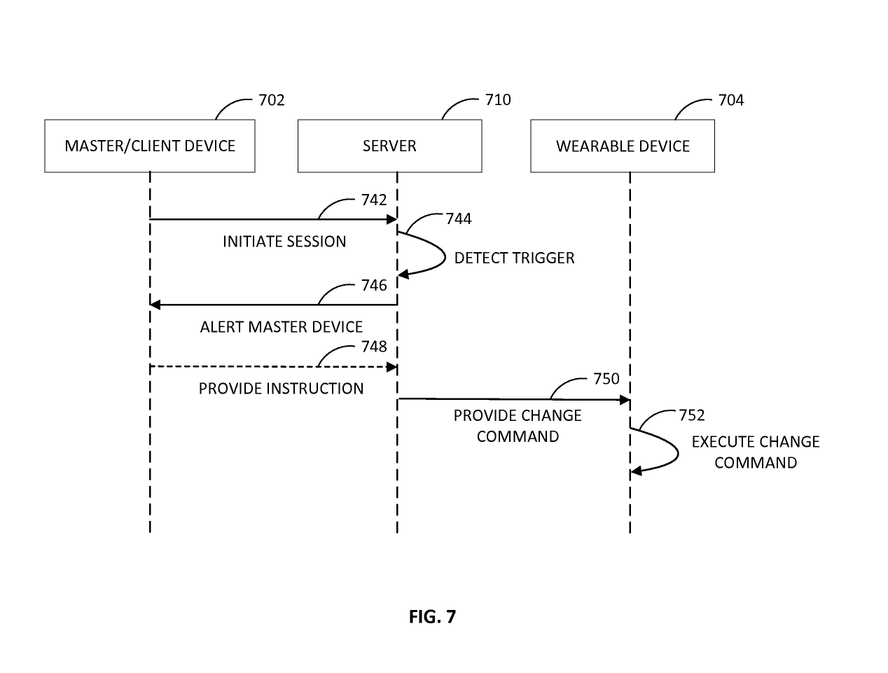

FIG. 7 illustrates an example usage flow involving a master (or client) device 702, a server 710, and wearable device 704. At 742, master device 702 may initiate a session with server 710. In embodiments, initiating a session may include sending a notification that wearable device 704 is to be used, updating a profile, setting performance parameters/thresholds/rules relating to the session, etc. A session may be initiated automatically by master device 702 (e.g., based on settings, when wearable device 704 is turned on, etc.), or may be initiated at the request of a user of master device 702 via a user interface of master device 702. At 744, server 710 may detect a trigger, similar to the detecting of a trigger as was described above with reference to FIG. 5. At 746, server 710 may send an alert to master device 702 that a trigger was detected. In an embodiment, master device 702 may provide instruction(s) 748 to server 710 in response to the alert. In an embodiment, master device 702 may automatically provide the instruction(s) to server 710 (e.g., based on the trigger, based on settings, etc.). In another embodiment, master device 702 may present the alert to a user of master device 702, and the user may input an instruction to master device 702 via a user interface of master device 702 to relay to server 710. At 750, server 710 may provide a change command to wearable device 704 based on the trigger and/or instruction(s). At 752, wearable device 704 may execute the change command, similar to the execution of the change command described above with reference to FIG. 5.

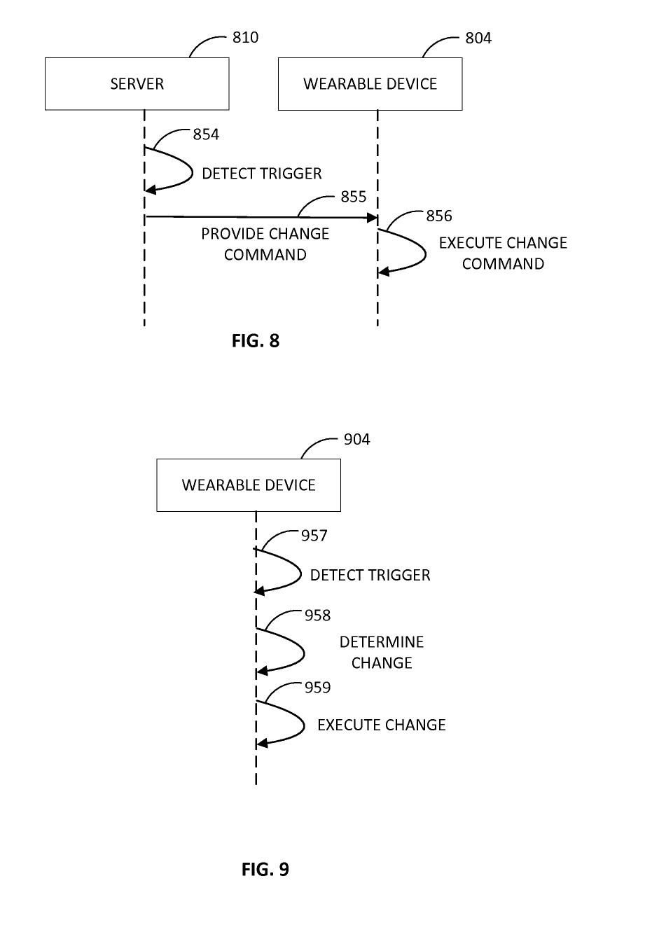

FIG. 8 illustrates an example usage flow involving a server 810 and wearable device 804. At 854, server 810 may detect a trigger, similar to the detecting of a trigger as was described above with reference to FIG. 5. At 855, server 810 may provide a change command to wearable device 804 based on the detected trigger. At 856, wearable device 804 may execute the change command, similar to the execution of the change command described above with reference to FIG. 5. In this implementation, the setting up of performance criteria/rules may be performed offline, may be done by a third party, or may be pre-set as default settings. As an example, this implementation may be useful as a service provided by an amusement park, where a wearable device may be provided to, and worn by, a child, and if server 810 detects that the child has left the boundaries of the park or is in any restricted areas (triggers), server 810 may provide a change command to wearable device 804 to display a request to alert security or sound an alarm to draw attention to the child.

FIG. 9 illustrates an example usage flow involving a standalone wearable device 904. At 957, a trigger may be detected by wearable device 904. At 958, wearable device 904 may determine a change to be made to its perceivable interface based on the detected trigger. At 959, wearable device 904 may execute the change on its perceivable interface. In an embodiment, wearable device 904 may be implemented as a full computing device with user interface, which may facilitate any of the setup and performance functionality described herein. In one of its simplest forms, this standalone implementation may have the capability of, for example, detecting one or more other wearable devices in a predetermined proximity that are currently presenting the same output (e.g., visual pattern, audio, etc.) as wearable device 904, and changing the output to preserve uniqueness of apparel.

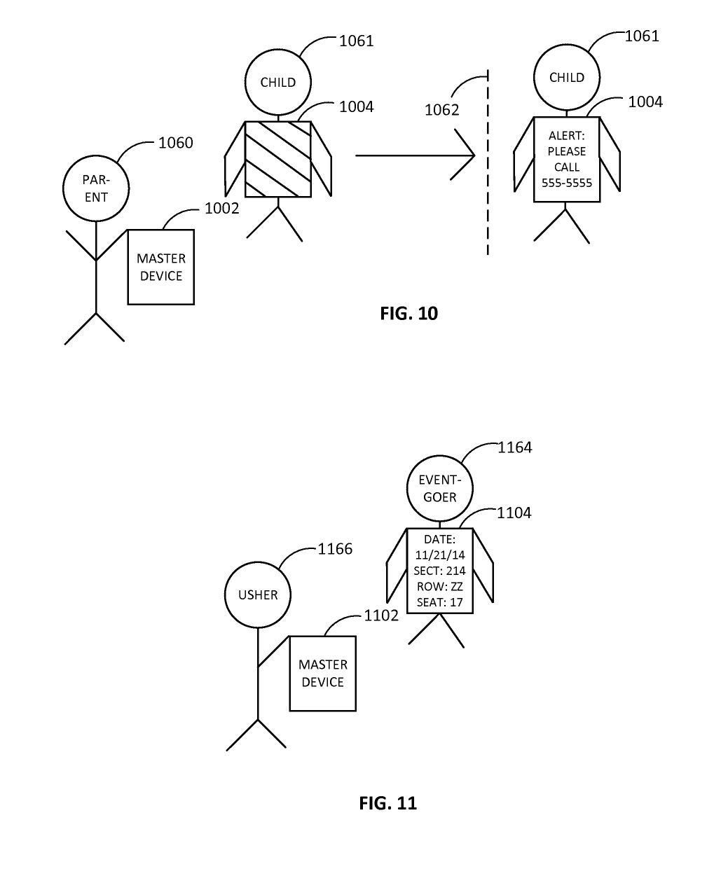

FIGS. 10-12 are block diagrams showing example scenarios or use cases that may assist in understanding how embodiments may be used in practical application. These are only example scenarios and are not meant to limit the embodiments described herein. Many other scenarios may be contemplated, as would be understood by one of ordinary skill in the relevant art.

FIG. 10 illustrates a scenario where a parent 1060 and child 1061 (or any being who may need to be constantly monitored (e.g., an elder person, a pet, etc.) may be entering a crowded area, such as a mall, a large sporting event or concert, a fair or festival, amusement park, etc. Parent 1060 may have a mobile device that may be used as a master device 1002 to control wearable device 1004 that is worn by the child 1061. The master device 1002, or another device, may have been used by parent 1060 to set up a profile and/or settings for wearable device 1004 that specifies criteria/rules/etc. used to control wearable device 1004. For example, parent 1060 may have set a pattern to be displayed on wearable device 1004 (initially shown as diagonal stripes, but may be any pattern or even no pattern (e.g., off)) and may have also set performance criteria or rules. For example, the performance criteria/rules may specify that, when the child 1061 becomes located further than a specified distance away from parent 1060 (or master device 1002) and/or ventures outside a specified boundary (e.g., a mall building), here shown as boundary 1062, wearable device 1004 is to change from the diagonal stripes to a message indicating an alert (e.g., a request to call the parent, alert security, etc.) or a very noticeable color or brightness or audible sound that may make the child more easily identifiable. In this way, the performance criteria/rules may specify triggers that cause wearable device 1004 to change its perceivable interface (its output). In embodiments, audio may be used instead of, or in addition to, a visual pattern change. Furthermore, in embodiments, the performance criteria/rules may specify that, instead of automatically changing the perceivable interface of wearable device 1004, when triggers are detected, the parent 1060 may be notified via master device 1002 and may provide a response (e.g., what message/pattern/sound to output from wearable device 1004). In a further embodiment, a parent may simply not be able to locate their child and may proactively input a request on master device 1002 to send a change command to wearable device 1004. Master device 1002 may then instruct wearable device 1004 to make any requested changes in its perceivable interface that may make child 1061 more identifiable.

In an embodiment, wearable device 1004 (or a bridge device, if used) may be configured to instruct wearable device 1004 to change its perceivable interface in the event that a communication connection between master device 1002 (or a server, if used) and wearable device 1004 has been lost. For example, in the scenario described with reference to FIG. 10, if a child is missing and communications are lost, the perceivable interface of wearable device 1004 may automatically change to make the child more noticeable (e.g., by sounding an audio alarm or changing to a bright visual pattern).

FIG. 11 shows a scenario in which an event-goer 1164 is about to enter an event (e.g., a sporting event, play, concert, etc.). An usher 1166 may be present at the entrance to the event (e.g., at a main or section entrance of a stadium, arena, theater, etc.). Usher 1166 may have a mobile device, such as a wand, smart phone, etc., that may be used as a master device 1102 to control wearable device 1104 that is worn by event-goer 1164. In this scenario, event organizers may have set criteria/rules/etc. such that master device 1102 may recognize certain wearable devices in its proximity (e.g., via radio frequency identification (RFID) or other identification method using close-range communication). In FIG. 11, master device 1102 may recognize wearable device 1104 and may provide a command to wearable device 1104 to display valid ticket information for this particular event. Once displayed on wearable device 1104, usher 1166 may allow event-goer 1164 to enter the venue or may direct event-goer 1164 to his or her seat. In an embodiment, wearable device 1104 may have been provided to event-goer 1164 as his or her “ticket” to get in to the event. In this embodiment, if wearable device 1104 is not a valid ticket, when usher 1166 directs master device 1102 to command wearable device 1104 to display the valid ticket information, wearable device 1104 may display a message indicating that it is not a ticket for this particular event, in which case the usher 1166 may ask the event-goer to leave the event.

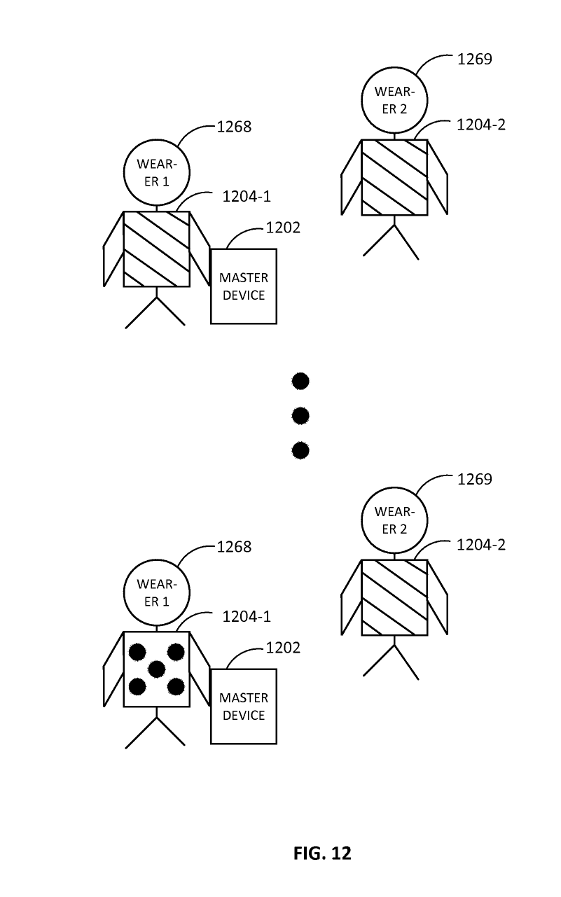

FIG. 12 shows a scenario in which a wearer 1268 (wearer 1) of a wearable device 1204-1 comes within a specified proximity of a wearer 1269 (wearer 2) who is wearing a wearable device 1204-2 that is displaying the same pattern as wearable device 1204-1. Wearer 1268 may have a mobile device that may be used as a master device 1202 to control wearable device 1204-1 that is worn by wearer 1268. The master device 1202, or another device, may have been used by wearer 1268 to set up a profile for wearable device 1204-1 that specifies criteria/rules used to control wearable device 1204-1. For example, wearer 1268 may have set a pattern to be displayed on wearable device 1204-1 (initially shown as diagonal stripes) and may have also set performance criteria/rules. For example, the performance criteria/rules may specify that, when another wearable device 1204-2 displaying the same pattern as wearable device 1204-1 comes within a specified proximity of wearable device 1204-1 (or master device 1202), wearable device 1204-1 is to change from the diagonal stripes to a different pattern (e.g., polka-dots, as shown in the example of FIG. 12). In this way, the performance criteria/rules specify triggers that cause wearable device 1204-1 to change its perceivable interface. In embodiments, the performance criteria/rules may specify that, instead of automatically changing the perceivable interface of wearable device 1204-1, when triggers are detected, the wearer 1268 may be notified via master device 1202 and may provide a response (e.g., what new pattern to display on wearable device 1204-1, do nothing, etc.). Master device 1202 may then instruct wearable device 1204-1 to make any requested changes in wearable device 1204-1 based on the response.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The terms software and firmware, as used herein, refer to a computer program product including at least one computer readable medium having computer program logic, such as computer-executable instructions, stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, SRAM, DRAM, a hard drive, a solid state drive, or other data storage device.

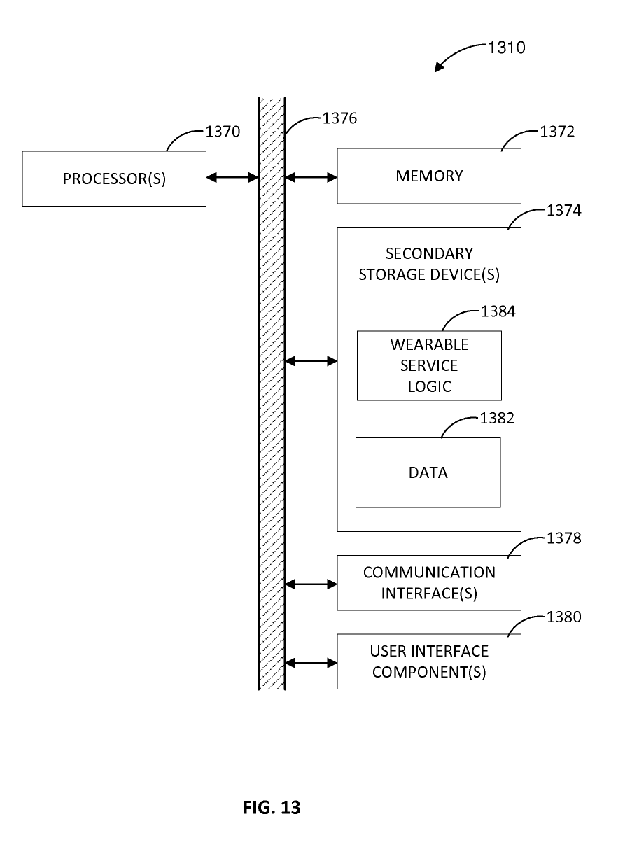

As stated above, in embodiments, some or all of the features described herein may be implemented as hardware, software, and/or firmware. Such embodiments may be illustrated in the context of example computing systems 1310, 1402, 1504, and 1608, as shown in FIGS. 13-16. Computing system 1310 shows an example implementation of a server (such as server 310/410/610/710/810), according to an embodiment. Computing system 1402 shows an example implementation of a master device or client device (such as device 102/202/302/402/502/602/702/1002/1102/1202), according to an embodiment. Computing system 1504 shows an example implementation of a wearable device (such as wearable device 104/204/304/404/504/604/704/804/904/1004/1104/1204), according to an embodiment. Computing system 1608 shows an example implementation of a bridge device (such as bridge device 208/408/608), according to an embodiment.

Computing system 1310 (FIG. 13) may include one or more central processing unit(s) (CPU), such as one or more processors 1370, connected to memory 1372, and one or more secondary storage devices 1374 by a link 1376 or similar mechanism. The processor(s) 1370 may include one or more logic units for carrying out the methods described herein. In embodiments, other logic units may also be present. One of ordinary skill in the relevant art would recognize that the functions of the logic units may be executed by a single logic unit, or any number of logic units. Computing system 1310 may optionally include communication interface(s) 1378 and/or user interface components 1380. The communication interface(s) 1378 may be implemented in hardware or a combination of hardware and software, and may provide a wired or wireless network interface to a network, such as network(s) 106/206/306/406 in FIGS. 1-4. The user interface components 1380 may include, for example, a touchscreen, a display, one or more user input components (e.g., a keyboard, a mouse, etc.), a speaker, or the like, or any combination thereof. The one or more secondary storage devices 1374 may be, for example, one or more hard drives or the like, and may store data 1382 (e.g., wearable service data) and logic 1384 (e.g., wearable service logic) to be executed by one or more processor(s) 1370. In an embodiment, processor(s) 1370 may be microprocessors, and logic 1384 may be stored or loaded into memory 1372 for execution by processor(s) 1370 to provide the functions described herein. Note that while not shown, computing system 1310 may include additional components.

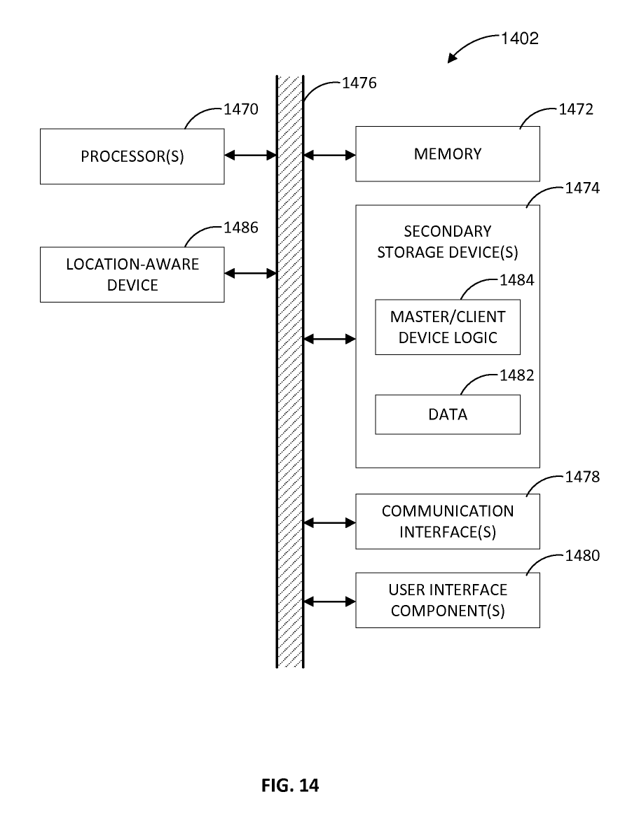

Computing system 1402 (FIG. 14) may include one or more central processing unit(s) (CPU), such as one or more processors 1470, connected to memory 1472, and one or more secondary storage devices 1474 by a link 1476 or similar mechanism. The processor(s) 1470 may include one or more logic units for carrying out the methods described herein. In embodiments, other logic units may also be present. One of ordinary skill in the relevant art would recognize that the functions of the logic units may be executed by a single logic unit, or any number of logic units. Computing system 1402 may optionally include communication interface(s) 1478 and/or user interface components 1480. The communication interface(s) 1478 may be implemented in hardware or a combination of hardware and software, and may provide a wired or wireless network interface to a network, such as network(s) 106/206/306/406 in FIGS. 1-4. The user interface components 1480 may include, for example, a touchscreen, a display, one or more user input components (e.g., a keyboard, a mouse, etc.), a speaker, or the like, or any combination thereof. The one or more secondary storage devices 1474 may be, for example, one or more hard drives or the like, and may store data 1482 (e.g., wearable service application data) and logic 1484 (e.g., master/client device logic) to be executed by one or more processor(s) 1470. In an embodiment, processor(s) 1470 may be microprocessors, and logic 1484 may be stored or loaded into memory 1472 for execution by processor(s) 1470 to provide the functions described herein. Computing system 1402 may optionally include a location-aware device 1486, such as a global positioning system (GPS) or other location-aware device. Note that while not shown, computing system 1402 may include additional components.

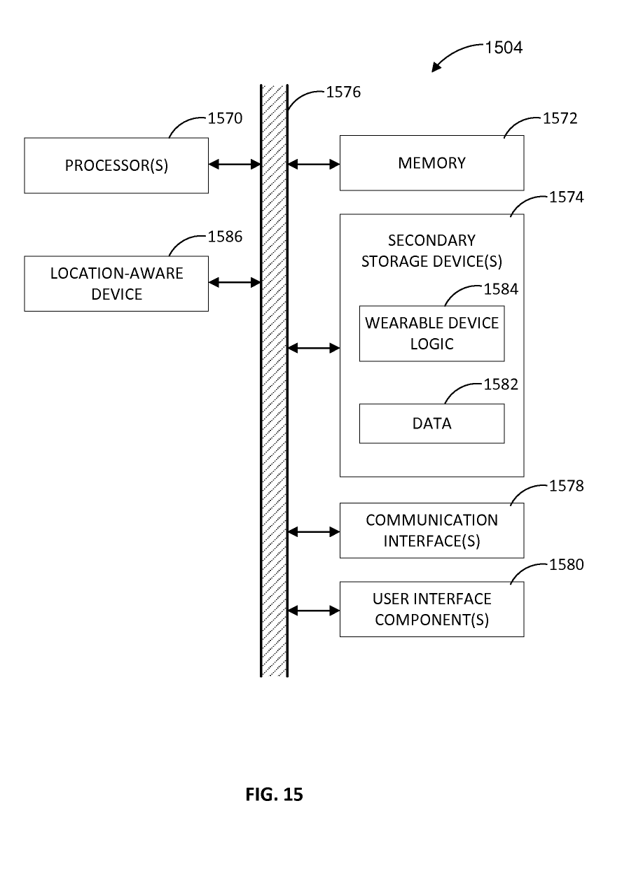

Computing system 1504 (FIG. 15) may include one or more central processing unit(s) (CPU), such as one or more processors 1570, connected to memory 1572, and one or more secondary storage devices 1574 by a link 1576 or similar mechanism. The processor(s) 1570 may include one or more logic units for carrying out the methods described herein. In embodiments, other logic units may also be present. One of ordinary skill in the relevant art would recognize that the functions of the logic units may be executed by a single logic unit, or any number of logic units. Computing system 1504 may optionally include communication interface(s) 1578 and/or user interface components 1580. The communication interface(s) 1578 may be implemented in hardware or a combination of hardware and software, and may provide a wired or wireless network interface to a network, such as network(s) 106/206/306/406 in FIGS. 1-4. The user interface components 1580 may include, for example, a touchscreen, a display, one or more user input components (e.g., a keyboard, a mouse, etc.), a speaker, or the like, or any combination thereof. The one or more secondary storage devices 1574 may be, for example, one or more hard drives or the like, and may store data 1582 (e.g., wearable service application data) and logic 1584 (e.g., wearable device logic) to be executed by one or more processor(s) 1570. In an embodiment, processor(s) 1570 may be microprocessors, and logic 1584 may be stored or loaded into memory 1572 for execution by processor(s) 1570 to provide the functions described herein. Computing system 1504 may optionally include a location-aware device 1586, such as a global positioning system (GPS) or other location-aware device. Note that while not shown, computing system 1504 may include additional components.

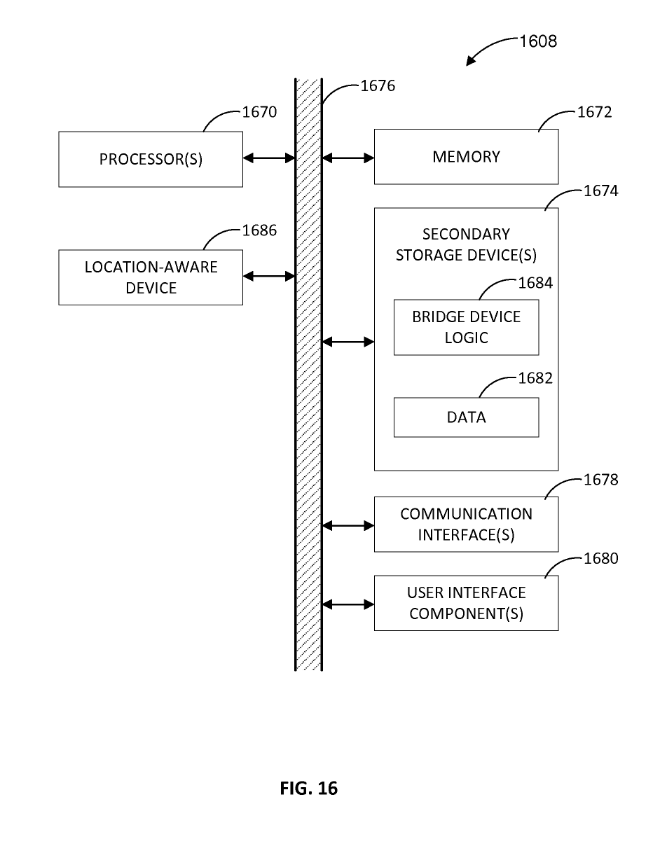

Computing system 1608 (FIG. 16) may include one or more central processing unit(s) (CPU), such as one or more processors 1670, connected to memory 1672, and one or more secondary storage devices 1674 by a link 1676 or similar mechanism. The processor(s) 1670 may include one or more logic units for carrying out the methods described herein. In embodiments, other logic units may also be present. One of ordinary skill in the relevant art would recognize that the functions of the logic units may be executed by a single logic unit, or any number of logic units. Computing system 1608 may optionally include communication interface(s) 1678 and/or user interface components 1680. The communication interface(s) 1678 may be implemented in hardware or a combination of hardware and software, and may provide a wired or wireless network interface to a network, such as network(s) 106/206/306/406 in FIGS. 1-4. The user interface components 1680 may include, for example, a touchscreen, a display, one or more user input components (e.g., a keyboard, a mouse, etc.), a speaker, or the like, or any combination thereof. The one or more secondary storage devices 1674 may be, for example, one or more hard drives or the like, and may store data 1682 (e.g., wearable service application data) and logic 1684 (e.g., bridge device logic) to be executed by one or more processor(s) 1670. In an embodiment, processor(s) 1670 may be microprocessors, and logic 1684 may be stored or loaded into memory 1672 for execution by processor(s) 1670 to provide the functions described herein. Computing system 1608 may optionally include a location-aware device 1686, such as a global positioning system (GPS) or other location-aware device. Note that while not shown, computing system 1608 may include additional components.

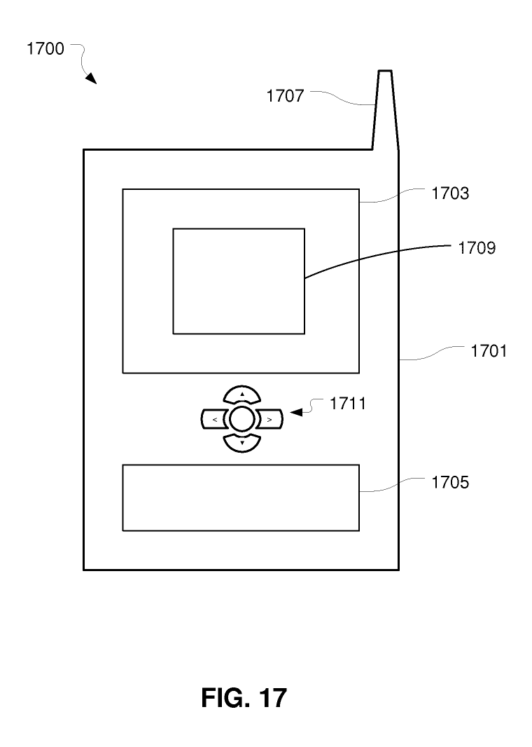

Computing systems 1310/1402/1504/1608 may be embodied in varying physical styles or form factors. FIG. 17 illustrates embodiments of a small form factor device 1700 in which any one or more of systems 1310/1402/1504/1608 may be embodied. In embodiments, for example, device 1700 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 17, device 1700 may comprise a housing 1701, a display 1703, an input/output (I/O) device 1705, and an antenna 1707. Device 1700 also may comprise navigation features 1711. Display 1703 may comprise any suitable display unit for displaying information 1709 appropriate for a mobile computing device. I/O device 1705 may comprise any suitable I/O device for entering information into a mobile computing device. Examples for I/O device 1705 may include an alphanumeric keyboard, a numeric keypad, a touch pad, input keys, buttons, switches, rocker switches, microphones, speakers, voice recognition devices and software, and so forth. Information also may be entered into device 1700 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate arrays (FPGA), logic gates, registers, semiconductor devices, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

In the foregoing description, embodiments have been presented that provide contextually interactive apparel in practical implementations and applications, including finding a wearer, protecting a wearer, informing a consumer, preserving uniqueness of apparel, etc. Implementations may range from a standalone wearable device to a master/wearable device implementation to a cloud-based or server-based service. The wearable device in the adaptive apparel may interact with devices to change its perceivable interface based on contextual triggers and/or direct requests. Information presented on the perceivable interface may be shared with limited trust models.

The particular examples and scenarios used in this document are for ease of understanding and are not to be limiting. Many other examples, scenarios, and uses may be contemplated. For example, if there is an emergency, or if there is an altercation or other problem in a crowded area or event, a nearby user and/or wearer of a wearable device may change the output on the wearable device so that authorities, security, etc., may find the exact location of the problem quickly. In another example, the technologies disclosed herein may be used to allow a master device to control a plurality of wearable devices in a choreographed manner. In the concert event example discussed above, the event sponsors may have provided the event-goers with their wearable devices (e.g., as wearable tickets). A master device may be able to control any or all of the wearable devices in a choreographed manner to create a stadium- or arena-wide presentation that includes visual and/or audio from the wearable devices. In this way, the event-goers, via their wearable devices, may become part of the show. In one example, wearable device interfaces may be aggregated where several wearable devices may be prompted to display at least a part of an image or moving image/video. In an embodiment, the choreographed output of a wearable device may be based on a seat location assigned to the wearable device. The seat location assigned to a particular wearable device may be changeable (e.g., by a user, wearer, and/or third party (e.g., event organizer)) for situations where a person changes seats. In another embodiment, the choreographed output of a wearable device may be based on geo-location (GPS coordinates) of the wearable device, which may be useful in situations where participants are not assigned seats (e.g., general admission) or have moved to different seats than the ones originally assigned to them.

Additional features may also be contemplated that may be useful to users of wearable devices. For example, records of wearable device events may be maintained. In an embodiment, every time a trigger and/or a direct request causes a wearable device to react, data regarding that trigger/request and the wearable device reaction may be recorded. This may be useful information to an authorized user of the wearable device or to a centralized wearable device service. This information may also be used to “learn” behavior to be used to recommend or create default profiles, to remember the most useful session settings for a particular wearer, to recommend future events, etc.

Moreover, features described herein may be used in many other contexts, as would be understood by one of ordinary skill in the relevant art. For example, the technologies described herein may deter shoplifting in that a wearable device that is taken from a store without being paid for may automatically, or by remote request, change its perceivable interface to alert others that it has been stolen. For example, an audible alarm may sound from the wearable device, or a message may be displayed that the item has been stolen and that authorities should be contacted.

The following examples pertain to further embodiments.

Example 1 may include a master device to direct a change in an interface of a wearable device, the master device comprising: a processor; and a communications interface in communication with the processor and a network, wherein the processor is to: detect a trigger; and provide a change command to an interface controller of the wearable device based on the trigger, the interface controller in communication with the processor via the network, wherein the interface controller is to direct a change in an interface of the wearable device, based on the change command, that is perceivable by persons in proximity of the wearable device.

Example 2 may include the subject matter of Example 1, wherein the trigger includes an explicit request from the master device.

Example 3 may include the subject matter of Example 1, wherein the trigger includes an explicit request from the master device that is input to the master device from a user of the master device.

Example 4 may include the subject matter of Example 1, wherein the trigger includes a determination that the wearable device is outside a predetermined boundary or beyond a predetermined proximity of the master device.

Example 5 may include the subject matter of Example 1, wherein the trigger includes a determination that a pattern displayed on another wearable device in a predetermined proximity of the wearable device is similar to a pattern displayed on the wearable device.

Example 6 may include the subject matter of Example 1, wherein the master device is a user device of a person other than a wearer of the wearable device.

Example 7 may include the subject matter of Example 1, wherein the master device is a server of a cloud-based service for changing interfaces of wearable devices.

Example 8 may include the subject matter of Example 1, wherein the master device is a bridge device directed by a user device of a person other than a wearer of the wearable device.

Example 9 may include the subject matter of Example 1, wherein the master device is a user device of a wearer of the wearable device.

Example 10 may include the subject matter of Example 1, wherein the master device is the wearable device.

Example 11 may include the subject matter of Example 1, wherein the directed change of the interface of the wearable device includes a change of a visual pattern on a display of the wearable device to a resulting visual pattern.

Example 12 may include the subject matter of Example 11, wherein the resulting visual pattern includes an artistic pattern.

Example 13 may include the subject matter of Example 11, wherein the resulting visual pattern includes text.

Example 14 may include the subject matter of Example 11, wherein the resulting visual pattern includes one or more of a name, a phone number, a customized message, or event ticket information.

Example 15 may include the subject matter of Example 11, wherein the change in the visual pattern includes a change in brightness level.

Example 16 may include the subject matter of Example 15, wherein the brightness level includes one or more of bright, muted, or matte.

Example 17 may include the subject matter of Example 1, wherein the directed change of the interface of the wearable device includes audio.

Example 18 may include the subject matter of Example 1, wherein the providing the change command includes providing one or more change commands to a plurality of wearable devices in a choreographed manner.

Example 19 may include the subject matter of Example 1, wherein the master device is one or more of the wearable device or a bridge device in a predetermined proximity of the wearable device, and wherein the trigger includes a determination that a connection from the master device to another master device has been lost.

Example 20 may include the subject matter of Example 1, wherein the processor is further directed to: determine other wearable devices that are concurrently being worn within a predetermined proximity of the wearable device; and provide information regarding the other wearable devices to a user of the master device.

Example 21 may include the subject matter of Example 1, wherein the processor is further directed to: determine other wearable devices that exist within a predetermined proximity of the wearable device; and provide information regarding the other wearable devices to a user of the master device.

Example 22 may include the subject matter of Example 1, wherein the communications interface includes one or more of wired communication technology, wireless communication technology, Bluetooth technology, Wi-Fi technology, near field communication technology, radio frequency (RF) technology, 1G technology, 2G technology, 2.5G technology, 3G technology, 3.5G technology, 4G technology, Long Term Evolution (LTE) technology, or WiMAX technology.

Example 23 may include the subject matter of Example 1, wherein the interface of the wearable device includes one or more of an electrical display, a chemical display, an optical fiber display, or an audio interface.

Example 24 may include an apparatus for directing a change in an interface of a wearable device, comprising: means for detecting a trigger; and means for providing a change command to an interface controller of the wearable device based on the trigger, wherein the interface controller is to direct a change in an interface of the wearable device, based on the change command, that is perceivable by persons in proximity of the wearable device.

Example 25 may include the subject matter of Example 24, wherein the trigger includes one or more of an explicit request from the apparatus, an explicit request from the apparatus that is input to the apparatus from a user of the apparatus, a determination that the wearable device is outside a predetermined boundary, a determination that the wearable device is beyond a predetermined proximity of the apparatus, or a determination that a pattern displayed on another wearable device in a predetermined proximity of the wearable device is similar to a pattern displayed on the wearable device.

Example 26 may include the subject matter of Example 24, wherein the directed change of the interface of the wearable device includes a change of a visual pattern on a display of the wearable device to a resulting visual pattern.

Example 27 may include the subject matter of Example 24, wherein the directed change of the interface of the wearable device includes audio.

Example 28 may include the subject matter of Example 24, wherein the means for providing the change command includes means for providing one or more change commands to a plurality of wearable devices in a choreographed manner.

In Example 29, Example 24 may optionally include: means for determining other wearable devices that are concurrently being worn within a predetermined proximity of the wearable device; and means for providing information regarding the other wearable devices to a user of the apparatus.

In Example 30, Example 24 may optionally include: means for determining other wearable devices that exist within a predetermined proximity of the wearable device; and means for providing information regarding the other wearable devices to a user of the apparatus.

Example 31 may include a computer-readable medium storing control logic configured to instruct a processor of a computing device to: detect a trigger; and provide a change command to an interface controller of a wearable device based on the trigger, wherein the interface controller is to direct a change in an interface of the wearable device, based on the change command, that is perceivable by persons in proximity of the wearable device.

Example 32 may include the subject matter of Example 31, wherein the trigger includes one or more of an explicit request from the computing device, an explicit request from the computing device that is input to the computing device from a user of the computing device, a determination that the wearable device is outside a predetermined boundary, a determination that the wearable device is beyond a predetermined proximity of the computing device, or a determination that a pattern displayed on another wearable device in a predetermined proximity of the wearable device is similar to a pattern displayed on the wearable device.

Example 33 may include the subject matter of Example 31, wherein the directed change of the interface of the wearable device includes a change of a visual pattern on a display of the wearable device to a resulting visual pattern.

Example 34 may include the subject matter of Example 31, wherein the directed change of the interface of the wearable device includes audio.

Example 35 may include the subject matter of Example 31, wherein the providing the change command includes providing one or more change commands to a plurality of wearable devices in a choreographed manner.

Example 36 may include the subject matter of Example 31, wherein the control logic is further configured to instruct the processor to: determine other wearable devices that are concurrently being worn within a predetermined proximity of the wearable device; and provide information regarding the other wearable devices to a user of the computing device.

Example 37 may include the subject matter of Example 31, wherein the control logic is further configured to instruct the processor to: determine other wearable devices that exist within a predetermined proximity of the wearable device; and provide information regarding the other wearable devices to a user of the computing device.

Example 38 may include a method for directing a change in an interface of a wearable device, comprising: detecting, by a computing device, a trigger; and providing a change command to an interface controller of the wearable device based on the trigger, wherein the interface controller is to direct a change in an interface of the wearable device, based on the change command, that is perceivable by persons in proximity of the wearable device.

Example 39 may include the subject matter of Example 38, wherein the trigger includes one or more of an explicit request from the computing device, an explicit request from the computing device that is input to the computing device from a user of the computing device, a determination that the wearable device is outside a predetermined boundary, a determination that the wearable device is beyond a predetermined proximity of the computing device, or a determination that a pattern displayed on another wearable device in a predetermined proximity of the wearable device is similar to a pattern displayed on the wearable device.

Example 40 may include the subject matter of Example 38, wherein the directed change of the interface of the wearable device includes a change of a visual pattern on a display of the wearable device to a resulting visual pattern.

Example 41 may include the subject matter of Example 38, wherein the directed change of the interface of the wearable device includes audio.

Example 42 may include the subject matter of Example 38, wherein the providing the change command includes providing one or more change commands to a plurality of wearable devices in a choreographed manner.

In Example 43, Example 38 may optionally include: determining other wearable devices that are concurrently being worn within a predetermined proximity of the wearable device; and providing information regarding the other wearable devices to a user of the computing device.

In Example 44, Example 38 may optionally include: determining other wearable devices that exist within a predetermined proximity of the wearable device; and providing information regarding the other wearable devices to a user of the computing device.

Example 45 may include at least one machine readable medium comprising a plurality of instructions that in response to being executed on a computing device, cause the computing device to carry out a method according to any one of Examples 38-44.

Example 46 may include an apparatus configured to perform the method of any one of Examples 38-44.

Example 47 may include a computer system to perform the method of any one of Examples 38-44.

Example 48 may include a machine to perform the method of any one of Examples 38-44.

Example 49 may include an apparatus comprising means for performing the method of any one of Examples 38-44.

Example 50 may include a computing device comprising memory and a chipset configured to perform the method of any one of Examples 38-44.

Example 51 may include a wearable device, comprising: an interface; an interface controller; and a communications interface in communication with the interface controller and a network, wherein the interface controller is to: receive an interface change command; and direct a change in the interface, based on the change command, that is perceivable by persons in proximity of the wearable device.

Example 52 may include the subject matter of Example 51, wherein the interface change command is received from a master device other than the wearable device.

Example 53 may include the subject matter of Example 51, wherein the interface change command is received from a processor of the wearable device.

Example 54 may include the subject matter of Example 53, wherein the receiving the interface change command from the processor is in response to a trigger detected by the processor.

Example 55 may include the subject matter of Example 54, wherein the trigger includes a determination that the wearable device is outside a predetermined boundary.

Example 56 may include the subject matter of Example 54, wherein the trigger includes a determination that a pattern displayed on another wearable device in a predetermined proximity of the wearable device is similar to a pattern displayed on the wearable device.

Example 57 may include the subject matter of Example 51, wherein the interface includes a visual display, and wherein the directed change of the interface includes a change of a visual pattern on the visual display to a resulting visual pattern.

Example 58 may include the subject matter of Example 57, wherein the visual display includes one or more of an electrical display, a chemical display, or an optical fiber display.

Example 59 may include the subject matter of Example 51, wherein the interface includes an audio interface, and wherein the directed change of the interface includes audio.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons of ordinary skill in the relevant art that various changes in form and detail may be made therein without departing from the scope of the methods and systems disclosed herein. Thus, the breadth and scope of the claims should not be limited by any of the exemplary embodiments disclosed herein.

As used in this application and in the claims, a list of items joined by the term “one or more of” can mean any combination of the listed terms. For example, the phrases “one or more of A, B or C” and “one or more of A, B, and C” can mean A; B; C; A and B; A and C; B and C; or A, B and C.

1.-25. (canceled)

26. An apparatus, comprising:
a controller configured to interface with an interactive wearable garment to control a human-perceptible feature of the garment based on one or more parameters.

27. The apparatus of claim 26, wherein the controller is further configured to:
control the garment to exhibit and/or alter the human-perceptible feature of the garment based on a location of the garment relative to one or more of the controller, a user-definable location, and a user-definable geographic area.

28. The apparatus of claim 26, wherein the controller is further configured to:
control the garment to exhibit and/or alter the human perceptible feature of the garment upon establishing wireless communications with the garment.

29. The apparatus of claim 26, further including a near-field communication device, wherein the controller is further configured to:
control the garment to exhibit and/or alter the human perceptible feature through the near-field communication device when the garment is within a near field of the near-field communication device.

30. The apparatus of claim 26, wherein the controller is further configured to:
control the garment to exhibit and/or alter the human-perceptible feature of the garment in response to a user command.

31. The apparatus of claim 26, wherein the controller is further configured to:
control a visual feature of the garment based on the one or more parameters.

32. The apparatus of claim 31, wherein the controller is further configured to:
control one or more of a color, a pattern, and a text display of the garment based on the one or more parameters.

33. The apparatus of claim 26, wherein the controller is further configured to:
control an audible feature of the garment based on the one or more parameters.

34. The apparatus of claim 1, wherein the controller is further configured to:
simultaneously control each of multiple interactive wearable garments to exhibit and/or alter human perceptible features of the respective garments in a choreographed fashion.

35. The apparatus of claim 1, wherein the controller is further configured to:
control a first interactive wearable garment to alter a human-perceptible feature of the first interactive wearable garment based on a human-perceptible feature of a second interactive wearable garment.

36. The apparatus of claim 35, wherein the controller is further configured to:
determine the human-perceptible feature of the second garment when the first and second garments are within a range of one another;
compare the human-perceptible feature of the first garment to the human-perceptible feature of the second garment; and
selectively alter the human-perceptible feature of the first garment to distinguish the first garment from the second garment based on the comparison.

37. The apparatus of claim 26, wherein the controller is further configured to:
configure the garment to exhibit and/or alter the human-perceptible feature of the garment if a wireless communication device of the garment is unable to communicate with the controller.

38. A non-transitory computer readable medium encoded with a computer program that includes instructions to cause a processor of a controller to:
interface with an interactive wearable garment to control a human-perceptible feature of the garment based on one or more parameters.

39. The non-transitory computer readable medium of claim 38, further including instructions to cause the processor to:
control the garment to exhibit and/or alter the human-perceptible feature of the garment based on a location of the garment relative to one or more of the controller, a user-definable location, and a user-definable geographic area.

40. The non-transitory computer readable medium of claim 38, further including instructions to cause the processor to:
control the garment to exhibit and/or alter the human perceptible feature of the garment upon establishing wireless communications with the garment.

41. The non-transitory computer readable medium of claim 38, further including instructions to cause the processor to:
control the garment to exhibit and/or alter the human perceptible feature through a near-field communication device when the garment is within a near field of the near-field communication device.

42. The non-transitory computer readable medium of claim 38, further including instructions to cause the processor to:
control the garment to exhibit and/or alter the human-perceptible feature of the garment in response to a user command.

43. The non-transitory computer readable medium of claim 38, further including instructions to cause the processor to:
control a visual feature of the garment based on the one or more parameters.

44. The non-transitory computer readable medium of claim 43, further including instructions to cause the processor to:
control one or more of a color, a pattern, and a text display of the garment based on the one or more parameters.

45. The non-transitory computer readable medium of claim 38, further including instructions to cause the processor to:
control an audible feature of the garment based on the one or more parameters.

46. The non-transitory computer readable medium of claim 38, further including instructions to cause the processor to:
simultaneously control each of multiple interactive wearable garments to exhibit and/or alter human perceptible features of the respective garments in a choreographed fashion.

47. The non-transitory computer readable medium of claim 46, further including instructions to cause the processor to:
control a first interactive wearable garment to alter a human-perceptible feature of the first interactive wearable garment based on a human-perceptible feature of a second interactive wearable garment.

48. The non-transitory computer readable medium of claim 47, further including instructions to cause the processor to:
determine the human-perceptible feature of the second garment when the first and second garments are within a range of one another;
compare the human-perceptible feature of the first garment to the human-perceptible feature of the second garment; and
selectively alter the human-perceptible feature of the first garment to distinguish the first garment from the second garment based on the comparison.

49. The non-transitory computer readable medium of claim 38, further including instructions to cause the processor to:
configure the garment to exhibit and/or alter the human-perceptible feature of the garment if a wireless communication device of the garment is unable to communicate with the controller.
